(19) United States
(12) Patent Application Publication
(10) Pub. No.: US 2026/0089525 A1
(43) Pub. Date: Mar. 26, 2026

(54) INFORMATION PROCESSING METHOD AND DEVICE

(71) Applicant: Beijing Xiaomi Mobile Software Co., Ltd., Beijing (CN)

(72) Inventor: Xuhua TAO, Beijing (CN)

(73) Assignee: Beijing Xiaomi Mobile Software Co., Ltd., Beijing (CN)

(21) Appl. No.: 19/110,275

(22) PCT Filed: Sep. 13, 2022
(86) PCT No.: PCT/CN2022/118538

§ 371 Date: Mar. 10, 2025

(51) Int. Cl. H04W 24/08

(52) U.S. Cl. CPC H04W 24/08

(57) ABSTRACT

Provided in the embodiments of the present disclosure are an information processing method and apparatus, a communication device, and a storage medium. The method comprises: a user equipment (UE) receiving first instruction information sent by a network device, wherein the first instruction information is used for instructing the UE to execute first early measurement, a measurement delay of the first early measurement being less than a measurement delay of second early measurement executed by the UE on the basis of an early-measurement configuration; and executing the first early measurement according to the first instruction information, wherein a measurement result of the first early measurement is at least used for the network device to configure carrier aggregation and/or dual-connectivity of the UE.

### CROSS-REFERENCE TO RELATED APPLICATIONS

The present application is a U.S. National Stage of International Application No. PCT/CN2022/118538 filed on Sep. 13, 2022, the entire contents of which are incorporated herein by reference for all purposes.

### TECHNICAL FIELD

The present disclosure relates to, but is not limited to, the field of wireless communication technology, and in particular, to an information processing method and device, a communication device, and a storage medium.

### BACKGROUND

In order to support a rapid establishment of dual-connectivity (DC) and/or carrier aggregation (CA) connection, a user equipment (UE) may perform a carrier measurement in idle or inactive state, and then after entering into a connection state, report the measurement result to a network, so that the network may determine whether to configure the dual connectivity or carrier aggregation based on the reported measurement result. Such measurement in the idle or inactive state may be collectively referred to as an early measurement.

### SUMMARY

Embodiments of the present disclosure provide an information processing method and device, a communication device, and a storage medium.

A first aspect of the embodiments of the present disclosure provides an information processing method, performed by a user equipment (UE), including:
receiving first indication information sent by a network device, wherein the first indication information is configured to indicate the UE to perform a first early measurement, and a measurement delay of the first early measurement is less than a measurement delay of a second early measurement performed by the UE based on an early measurement configuration; and
performing the first early measurement based on the first indication information, wherein a measurement result of the first early measurement is at least configured for the network device to configure carrier aggregation and/or dual connectivity of the UE.

A second aspect of the embodiments of the present disclosure provides an information processing method, performed by a network device, including:
sending first indication information to a UE, wherein the first indication information is configured to indicate the UE to perform a first early measurement, a measurement delay of the first early measurement is less than a measurement delay of a second early measurement performed by the UE based on an early measurement configuration, and a measurement result of the first early measurement is at least configured for the network device to configure carrier aggregation and/or dual connectivity of the UE.

A third aspect of the embodiments of the present disclosure provides an information processing device, applied to a UE, including:
a first receiving module, configured to receive first indication information sent by a network device, wherein the first indication information is configured to indicate the UE to perform a first early measurement, and a measurement delay of the first early measurement is less than a measurement delay of a second early measurement performed by the UE based on an early measurement configuration; and
a measuring module, configured to perform the first early measurement based on the first indication information, wherein a measurement result of the first early measurement is at least configured for the network device to configure carrier aggregation and/or dual connectivity of the UE.

A fourth aspect of the embodiments of the present disclosure provides an information processing device, applied to a network device, including:
a first sending module, configured to send first indication information to a UE, wherein the first indication information is configured to indicate the UE to perform a first early measurement, a measurement delay of the first early measurement is less than a measurement delay of a second early measurement performed by the UE based on an early measurement configuration, and a measurement result of the first early measurement is at least configured for the network device to configure carrier aggregation and/or dual connectivity of the UE.

A fifth aspect of the embodiments of the present disclosure provides a communication system, including:
a UE, configured to perform the information processing method according to the first aspect; and
a network device, configured to perform the information processing method according to the second aspect.

A sixth aspect of the embodiments of the present disclosure provides a communication device, including:
a processor; and
a memory storing executable instructions for the processor,
wherein the processor is configured to implement the information processing method according to the first or second aspect when running the executable instructions.

A seventh aspect of the embodiments of the present disclosure provides a computer storage medium having a computer executable program stored thereon that, when being executed by a processor, implements the information processing method according to the first or second aspect.

It should be understood that the above general description and the following detailed description are merely exemplary and explanatory and do not limit the present disclosure.

### BRIEF DESCRIPTION OF THE DRAWINGS

The accompanying drawings herein, which are incorporated into and form a part of the specification, illustrate embodiments that are consistent with the present disclosure and are used in conjunction with the specification to explain the principle of the embodiments of the present disclosure.

FIG. 1 is a schematic structure diagram of a wireless communication system according to an embodiment;

FIG. 2 is a flow diagram of an information processing method according to an embodiment;

FIG. 3 is a flow diagram of an information processing method according to an embodiment;

FIG. 4 is a flow diagram of an information processing method according to an embodiment;

FIG. 5 is a flow diagram of an information processing method according to an embodiment;

FIG. 6 is a flow diagram of an information processing method according to an embodiment;

FIG. 7 is a flow diagram of an information processing method according to an embodiment;

FIG. 8 is a flow diagram of an information processing method according to an embodiment;

FIG. 9 is a flow diagram of an information processing method according to an embodiment;

FIG. 10 is a schematic structure diagram of an information processing device according to an embodiment;

FIG. 11 is a schematic structure diagram of an information processing device according to an embodiment;

FIG. 12 is a schematic structure diagram of a UE according to an embodiment; and

FIG. 13 is a schematic structure diagram of a network device according to an embodiment.

### DETAILED DESCRIPTION

Embodiments will be described herein in detail, examples of which are represented in the accompanying drawings. When the following description relates to the accompanying drawings, the same numerals in the different figures indicate the same or similar elements unless otherwise indicated. The implementations described in the following embodiments do not represent all implementations consistent with the embodiments of the present disclosure. Rather, they are only examples of devices and methods consistent with some aspects of embodiments of the present disclosure.

The term used in the embodiments of the present disclosure is used solely for the purpose of describing particular embodiments and is not intended to limit the embodiments of the present disclosure. The singular forms of “a”, “said” and “the” used in the present disclosure are also intended to encompass the plural forms, unless clearly indicated otherwise in the context. It is to be also understood that the term “and/or” as used herein refers to and encompasses any or all possible combinations of one or more of the associated listed items.

It is to be understood that while the terms first, second, third, etc. may be used in the embodiments of the present disclosure to describe various types of information, such information should not be limited to these terms. These terms are only used to distinguish the same type of information from one another. For example, without departing from the scope of the embodiments of the present disclosure, a first parameter may also be referred to as a second parameter, and similarly, the second parameter may be referred to as the first parameter. Depending on the context, the word “if” as used herein may be interpreted as “at the time of . . . ” or “when . . . ” or “in response to determining”.

Referring to FIG. 1, FIG. 1 is a schematic structure diagram of a wireless communication system provided by an embodiment of the present disclosure. As shown in FIG. 1, the wireless communication system is a communication system based on the cellular mobile communication technology, and the wireless communication system may include a plurality of UEs 11 and a plurality of access devices 12.

The UE 11 may be a device that provides voice and/or data connectivity to a user. The UE 11 may communicate with one or more core network devices via a radio access network (RAN). The UE 11 may be an IoT UE, such as sensor device, mobile phone (or so-called ‘cellular’ phone), and computer with an IoT UE, which may be, for example, fixed, portable, pocket-sized, handheld, computer-integrated, or vehicle-mounted device, for example, a station (STA), a subscriber unit, a subscriber station, a mobile station, a mobile, a remote station, an access point, a remote terminal, an access terminal, a user terminal, a user agent, a user device or a user equipment (UE). Alternatively, the UE 11 may be an unmanned aerial vehicle device. Alternatively, the UE 11 may be an in-vehicle device, e.g., it may be a trip computer with a wireless communication capability, or a wireless communication device externally connected to a trip computer. Alternatively, the UE 11 may be a roadside device, e.g., it may be a street light, a signal light, or other roadside devices having a wireless communication capability.

The access device 12 may be a network-side device in the wireless communication system. The wireless communication system may be the 4^{th} generation mobile communication system, also known as a long term evolution (LTE) system, or may be a 5G system, also known as a new radio (NR) system or 5G NR system. Alternatively, the wireless communication system may be a further next generation system of the 5G system. The access network in the 5G system may be called NG-RAN (new generation-radio access network). Alternatively, the wireless communication system may be an MTC system.

The access device 12 may be an evolved base station (eNB) used in the 4G system. Alternatively, the access device 12 may be an access device (gNB) of a centralized distributed architecture used in the 5G system. When the access device 12 uses the centralized distributed architecture, it typically includes a central unit (CU) and at least two distributed units (DUs). The central unit is provided with a protocol stack of packet data convergence protocol (PDCP) layer, radio link control (RLC) layer, and media access control (MAC) layer, and the distributed unit is provided with a protocol stack of physical (PHY) layer. The specific implementation of the access device 12 is not limited in the embodiments of the present disclosure.

A wireless connection may be established between the access device 12 and the UE 11 via a wireless radio. In various implementations, the wireless radio is a wireless radio based on the 4th generation mobile communication network technology (4G) standard; alternatively, the wireless radio is a wireless radio based on the 5th generation mobile communication network technology (5G) standard, for example, the wireless radio is the new radio; alternatively, the wireless radio may be a wireless radio based on a further next generation mobile communication network technology standard based on the 5G.

In an embodiment, an E2E (End to End) or D2D (device to device) connection may also be established between the UEs 11, examples of which include V2V (vehicle to vehicle) communication, V2I (vehicle to infrastructure) communication, and V2P (vehicle to pedestrian) communication in a vehicle to everything (V2X) scenario or the like.

In an embodiment, the access device 12 may be located in a communication system that is integrated with a satellite communication system and can provide a connectivity service to a satellite and connect the satellite to the core network. For example, the access device 12 may be an access network device having a satellite gateway function in the communication system, such as a gateway device, a ground station device, a non-terrestrial network gateway (NTN-gateway)/satellite gateway, and the like.

In an embodiment, the wireless communication system described above may further include a core network device 13. The plurality of access network devices 12 are connected to the core network device 13 respectively.

In an embodiment, the core network device 13 may be a mobility management entity (MME) in the evolved packet core (EPC). Alternatively, the core network device may be a serving gateway (SGW), a public data network gateway (PGW), a policy and charging rules function unit (PCRF), a home subscriber server (HSS) or the like. The implementation form of the core network device 13 is not limited in the embodiments of the present disclosure.

In an embodiment, the core network device 13 may be an access and mobility management function (AMF), a unified data management (UDM), a gateway mobile location center (GMLC) network element, a network exposure function (NEF) network element, a policy control function (PCF) network element or the like. The implementation form of the core network device 13 is not limited in the embodiments of the present disclosure.

In order to facilitate the understanding of a person skilled in the art, the embodiment of the present disclosure enumerates a plurality of implementations to clearly illustrate the technical solution of the embodiment of the present disclosure. Of course, a person skilled in the art may understand that a plurality of embodiments provided in the embodiment of the present disclosures may be performed separately, or may be performed together with the method of other embodiments in the embodiment of the present disclosure, or may be performed together with some methods in other related technologies either separately or in combination therewith, which is not limited in the embodiment of the present disclosures.

To support fast establishment of DC or CA connection, the early measurement report (EMR) is introduced, i.e., a UE may conduct measurement and reporting based on early measurement configuration information in a non-connected state (e.g., an idle state or an inactive state). In the related technology, in some cases, the early measurement delay is long, and the long measurement latency may result in that a reliable early measurement result may not be reported timely, which may affect the configuration efficiency and use of the carrier aggregation or dual connectivity.

For example, the intra-frequency measurement delay is K_{carrier}*T_{detect,NR_Inter}, wherein K_{carrier} is a configured number of to-be-measured carriers for EMR, and T_{detect,NR_Inter} is shown in Table 1 below.

TABLE 1

| | | | T_{detect, NR}_{_{—}}_{Inter} [s] | T_{measure, NR}_{_{—}}_{Inter} [s] | T_{evaluate, NR}_{_{—}}_{Inter} [s] |
|---|---|---|---|---|---|
| DRX cycle | Scaling Factor (N1) | | (number of DRX | (number of DRX | (number of DRX |
| length [s] | FR1 | FR2^{Note1} | cycles) | cycles) | cycles) |
| 0.32 | 1 | 8 | 11.52 × N1 × 1.5 | 1.28 × N1 × 1.5 | 5.12 × N1 × 1.5 |
| | | | (36 × N1 × 1.5) | (4 × N1 × 1.5) | (16 × N1 × 1.5) |
| 0.64 | | 5 | 17.92 × N1 (28 × N1) | 1.28 × N1 (2 × N1) | 5.12 × N1 (8 × N1) |
| 1.28 | | 4 | 32 × N1 (25 × N1) | 1.28 × N1 (1 × N1) | 6.4 × N1 (5 × N1) |
| 2.56 | | 3 | 58.88 × N1 (23 × N1) | 2.56 × N1 (1 × N1) | 7.68 × N1 (3 × N1) |

^{Note1}
Applies for UE supporting power class 2&3&4. For UE supporting power class 1 or 5, N1 = 8 for all DRX cycle length.

According to a relevant protocol requirement, in Frequency Range 2 (FR2), the delay of detecting and measuring a carrier is very long, for example, in the case of discontinuous reception (DRX) cycle length of 320 ms, the delay of detecting a carrier is: DRX cycle length*(36×N1×1.5+4×N1×1.5)=320*40*8*1.5=153600 ms=153.6 s, which is about 2.5 minutes. In further consideration of the carrier number expansion factor, the delay will be further increased. Such a long delay requirement may result in that a reliable early measurement result may not be reported timely, therefore it is necessary to enhance the performance of the UE to perform the measurement for the CA and/or DC configuration in the unconnected state.

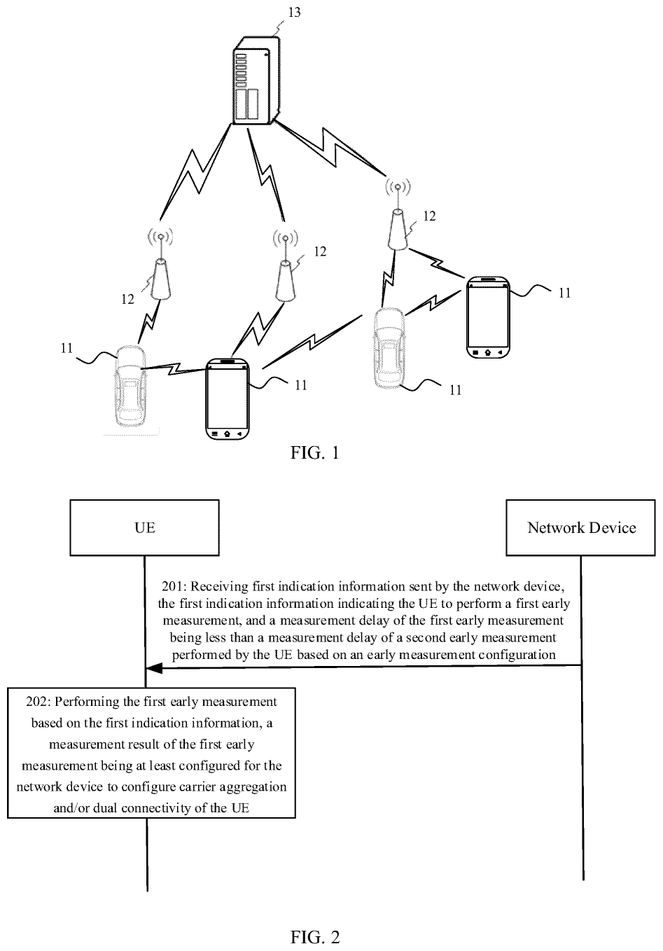

FIG. 2 is a flow diagram of an information processing method according to an embodiment. The information processing method is performed by a UE, and as shown in FIG. 2, the method includes:
step 201, receiving first indication information sent by a network device, wherein the first indication information is configured to indicate the UE to perform a first early measurement, and a measurement delay of the first early measurement is less than a measurement delay of a second early measurement performed by the UE based on an early measurement configuration; and
step 202, performing the first early measurement based on the first indication information, wherein a measurement result of the first early measurement is at least configured for the network device to configure carrier aggregation and/or dual connectivity of the UE.

Herein, the UE may be a mobile phone, a tablet computer, a laptop computer, a personal digital assistant (PDA), a wearable device, an Internet of Things (IoT) device, a narrow-band IoT (NB-IoT) device or the like.

The UE has a non-connected state and a connected state. For example, the wireless communication system of the UE is an LTE system, and the non-connected state refers to an idle state. The wireless communication system of the UE is a 5G NR system, and the non-connected state includes an idle state and an inactive state.

The UE may communicate with more than one network device and more than one type of network device simultaneously and/or be configured to communicate with them respectively. For example, the UE may have a dual connectivity with a network device supporting LTE and a network device supporting NR.

As an example, the UE may communicate with an eNB for LTE/E-UTRAN (Evolved Universal Terrestrial Radio Access Network) and a gNB for NR/NG-RAN.

The network device is a network side device, such as a gNB or an eNB or a base station in a subsequent evolved communication system.

In some examples, the first indication information may be configured to indicate a carrier to be measured when the UE performs the first early measurement.

The carrier to be measured by the first early measurement may be a potential carrier aggregation and/or a secondary carrier of a dual connectivity.

For example, the first indication information may include measurement carrier information, and the measurement carrier information indicates a carrier to be measured by the first early measurement.

In some examples, the number of carriers to be measured by the first early measurement is less than the number of carriers to be measured by the second early measurement.

In some examples, receiving the first indication information sent by the network device in step 201 may include one of:
receiving a first message sent by the network device, wherein the first message carries the early measurement configuration and the first indication information; or
receiving a second message sent by the network device, wherein the second message carries the first indication information and is different from the first message carrying the early measurement configuration and sent to the UE by the network device.

In some examples, the first message includes a radio resource control (RRC) release message and/or a system message.

The system message is for example a system information block (SIB) 4 in an NR system and/or a system information block 5 (SIB5) in an LTE/E-UTRAN system.

In some examples, the second message includes a paging message. The UE in the unconnected state in a resident cell may monitor a paging channel of that cell. The paging message is sent by the network device and may carry the first indication information.

In some examples, the early measurement configuration may include a list of to-be-measured carriers, configuration information of each to-be-measured carrier in the list of to-be-measured carriers, and a measurement reporting configuration. In addition, the early measurement configuration may include whether to configure a DRX timer for the UE, a cycle length of a specific configured DRX, or the like.

The configuration information of the to-be-measured carrier is configured to indicate a specific configuration of the UE to perform the early measurement for that to-be-measured carrier.

In some examples, the configuration information of the to-be-measured carrier includes, but is not limited to, measurement frequency point information, a list of measurement cells, and/or measurement frequency band information (e.g., frequency band indicator), etc.

The measurement frequency point information may include an absolute frequency point number for the NR carrier (e.g., ARFCN-ValueNR) and/or an absolute frequency point number for the E-UTRAN carrier (e.g., ARFCN-ValueEUTRA).

The measurement frequency band information is used for a frequency range of the to-be-measured carrier. The measurement frequency band information includes a frequency range 1 (FR1) and/or a frequency range 2 (FR2). The FR1 is the 5G Sub-6 GHZ (below 6 GHz) band and the FR2 is the 5G millimeter wave band.

In some examples, when the to-be-measured carrier is an NR carrier, the configuration information of the to-be-measured carrier may include a measurement configuration of a synchronization signal block (SSB) at a frequency point of the to-be-measured carrier, for example, an SSB measurement timing configuration (SMTC), SSB index information to be measured (e.g., an indication as to which SSB is to be measured), a number of SSBs to be averaged and/or a number of threshold SSBs to be merged, etc.

In some examples, the measurement reporting configuration may be used to indicate a reporting type, a quality threshold, and a number of beam-based measurements.

In some examples, the reporting type includes at least one of a reference signal receiving power (RSRP), a reference signal received quality (RSRQ), or a signal to interference plus noise ratio (SINR).

In some examples, in step 202 above, the UE performs the first early measurement in the unconnected state based on the first indication information.

The measurement result of the first early measurement may be used for the configuration of carrier aggregation and/or dual connectivity of the UE by the network device.

Specifically, the measurement result of the first early measurement may be used for the configuration of a secondary cell group (SCG) or a secondary cell (SCell) in carrier aggregation and/or dual connectivity of the UE by the network device.

The dual connectivity may be a dual connectivity of LTE and NR, specifically, a dual connectivity between E-UTRAN and NR, such as EN-DC or NE-DC, or a dual connectivity between two NR nodes, i.e., NR-DC.

In the information processing method provided by the embodiment of the present disclosure, the UE receives the first indication information sent by the network device, the first indication information is configured to indicate the UE to perform the first early measurement, and the measurement delay of the first early measurement is less than the measurement delay of the second early measurement performed by the UE based on the early measurement configuration; and then the UE performs the first early measurement based on the first indication information, which may reduce the delay caused by the early measurement execution, and thus enables fast configuration of carrier aggregation and/or dual connectivity of the UE.

In an embodiment, the first indication information includes:
measurement carrier information, configured to indicate a to-be-measured carrier.

In some examples, the to-be-measured carrier may be a downlink carrier or a carrier for downlink.

In some examples, the to-be-measured carrier indicated by the measurement carrier information may be included in the to-be-measured carrier indicated by the early measurement configuration, and the number of to-be-measured carriers indicated by the measurement carrier information is less than the number of to-be-measured carriers indicated by the early measurement configuration.

It is to be understood that the UE, when performing the first early measurement, may determine, from the early measurement configuration, relevant configuration information of the carrier to be measured by the first early measurement, and perform the first early measurement based on the relevant configuration information of the carrier to be measured by the first early measurement.

In the embodiment, the UE may perform the first early measurement based on the measurement carrier information included in the first indication information, such that the delay caused by performing the early measurement is reduced by performing the first early measurement with a smaller number of measurement carriers, and a fast configuration of carrier aggregation and/or dual connectivity of the UE is possible.

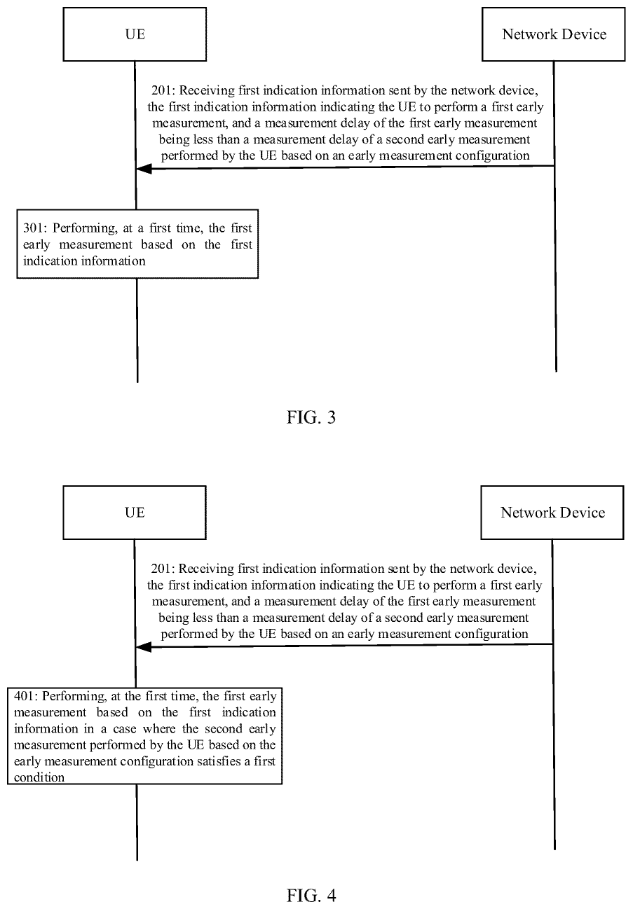

In an embodiment, as shown in FIG. 3, on the basis of FIG. 2, performing the first early measurement based on the first indication information may include:
step 301, performing, at a first time, the first early measurement based on the first indication information.

The UE may perform the first early measurement based on the first indication information at or after the first time.

In some examples, the first time may be a protocol-agreed time, a time indicated by the network device, or a time autonomously determined by the UE.

In an embodiment, the method may further include:
determining the first time based on a protocol agreement; or
determining the first time based on the first indication information; or,
determining the first time autonomously by the UE.

In some examples, the first indication information sent by the network device may include the first time or information related to the first time, and the UE may determine the first time based on the first indication information.

In an embodiment, the first time includes at least one of the following 1) to 4).

1) a Time at which the UE Receives a Paging Message from a Service Cell

The UE in the unconnected state in a resident cell monitors the paging channel of that cell. The paging message is sent by the network device and the UE in the unconnected state only monitors one paging time in a DRX cycle.

In some examples, the first time is a paging time at which the UE receives the paging message. In this case, regardless of whether the UE is paged or not, as long as the paging message is received by the UE at the paging time, the paging time may be used as the first time.

In other examples, the first time is a paging time at which the UE receives a paging message for paging the UE. The paging message for paging the UE carries identification information of the UE. In this case, if the UE receives the paging message for paging the UE at the paging time, the paging time may be used as the first time.

In some examples, the paging message is higher-layer RRC signaling, which may be physical layer signaling or media access control (MAC) layer signaling. For example, the paging message may be carried in a MAC CE (MAC control element).

2) a Time at which the UE Sends a Random Access Preamble to the Network Device

When the UE in the unconnected state access to the network and obtains an RRC connection, it first performs a random access procedure. During the random access procedure, the UE sends to the network device an MSG1 (message 1): a random access preamble.

The random access preamble may be used to inform the access network device about the random access request of the UE.

3) a Time at which the UE Sends an RRC Connection Setup Request to the Network Device

When the UE is in the idle state, the RRC connection setup process may be triggered when the UE is paged or wishes to initiate a paging. During the RRC connection setup process, the UE sends an RRC setup request to a network device (e.g., a base station). The time at which the UE sends the RRC connection setup request to the network device may be used as the first time.

4) a Time at which the UE Sends an RRC Connection Resume Request to the Network Device

When the UE is in the inactive state, the RRC connection resume process may be triggered when the UE is paged or has uplink data arrived. Unlike the UE in the idle state, the core network maintains the connection to the UE in the inactive state and the source network device keeps the context of that UE. The UE in the inactive state resumes the connection to the access network through the RRC resume process and resumes the connection to the core network.

During the RRC connection resume process, the UE may send an RRC resume request to the network device. The time at which the UE sends the RRC connection resume request to the network device may be used as the first time.

In an embodiment of the present disclosure, the UE performs the first early measurement based on the first indication information at any of the above first times, which may further reduce the delay caused by the early measurement, so that the network device may obtain the measurement result as soon as possible, and thus fast configure carrier aggregation and/or dual connectivity of the UE.

In an embodiment, as shown in FIG. 4, on the basis of FIG. 3, performing, at the first time, the first early measurement based on the first indication information may include:
step 401, performing, at the first time, the first early measurement based on the first indication information in a case where the second early measurement performed by the UE based on the early measurement configuration satisfies a first condition.

In the embodiment, the UE in the non-connected state may first perform the second early measurement based on the early measurement configuration sent by the network device, and only if the second early measurement satisfies the first condition, the UE may perform, at the first time, the first early measurement based on the first indication information.

In an embodiment, the first condition includes at least one of:
a measurement result of the second early measurement performed by the UE based on the early measurement configuration being invalid; or
the UE not obtaining the measurement result of the second early measurement performed based on the early measurement configuration.

If the cell reselected to by the UE in the unconnected state is a first cell, the measurement result of the second early measurement performed by the UE in a second cell before the cell reselection is invalid. Here, the first cell is different from the second cell.

If the UE stops the second early measurement after the UE enters the connected state from the unconnected state or moves out of the effective area or performs an Inter-RAT reselection during the execution of the second early measurement, the UE may not obtain the measurement result of the second early measurement.

In the embodiment, in the case where the second early measurement performed by the UE based on the early measurement configuration satisfies the first condition, the first early measurement is performed at the first time based on the first indication information, which can thus enable the network device to obtain a reliable early measurement result as early as possible, and realize fast configuration of aggregated carrier and/or dual connectivity of the UE.

In an embodiment, the first early measurement includes at least one of:
a layer 1 reference signal receiving power (L1-RSRP) measurement; or
a layer 3 reference signal receiving power (L3-RSRP) measurement.

The L1-RSRP measurement is an RSRP measurement based on layer 1 (physical layer), which RSRP measurement is not subject to the filtering process of layer 3 (network layer). In comparison with the L3-RSRP measurement, the L1-RSRP measurement allows for faster beam information measurement and reporting.

In some examples, both L1-RSRP and L3-RSRP measurements may be RSRP measurements performed based on SSB. In the downlink direction, a plurality of SSBs may be transmitted in a carrier band, and the SSB is transmitted to the UE with a fixed cycle, which may be 5 ms, 10 ms, 20 ms, 40 ms, 80 ms, or 160 ms. The UE may measure the RSRP for the received SSB.

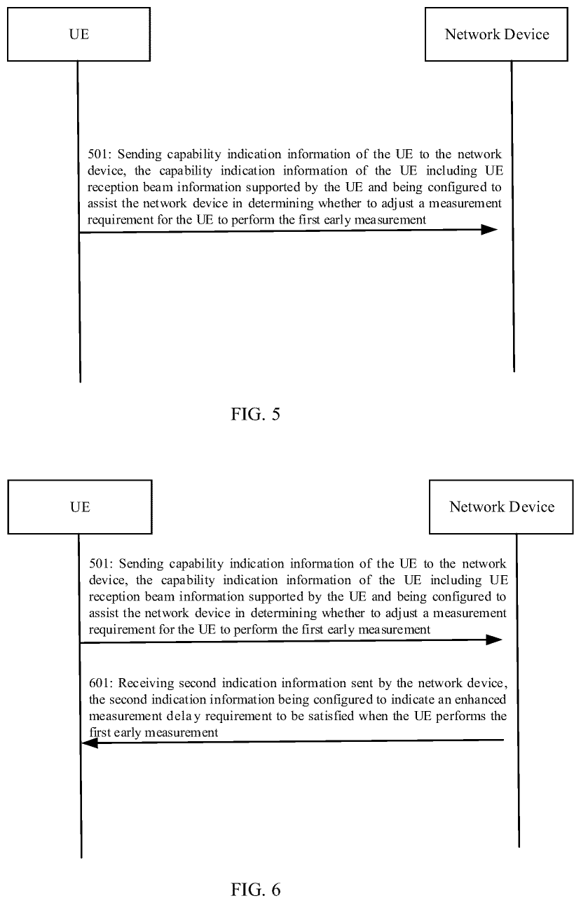

In an embodiment, as shown in FIG. 5, the method may further include:
step 501, sending capability indication information of the UE to the network device, wherein the capability indication information of the UE includes UE reception beam information supported by the UE and is configured to assist the network device in determining whether to adjust a measurement requirement for the UE to perform the first early measurement.

In some examples, the UE reception beam information may include a number of UE reception beams.

The UE may report the capability information regarding the number of reception beams of the UE itself to the network device via IE MeasAndMobParameters (measurement and mobility parameter) or E MeasAndMobParametersMRDC of MR-DC (Multi-RadioDualConnectivity) capability.

For example, if the number of reception beams X reported by the UE is 4, it means that the UE supports the simulation of reception beams in 4 different directions to receive the physical downlink control channel (PDCCH) and/or the physical downlink shared channel (PDSCH).

In an embodiment, as shown in FIG. 6, on the basis of FIG. 5, the method may further include:
step 601, receiving second indication information sent by the network device, wherein the second indication information is configured to indicate an enhanced measurement delay requirement to be satisfied when the UE performs the first early measurement.

Performing the first early measurement based on the first indication information in the above step 202 may include:
performing the first early measurement based on the first indication information and the second indication information.

In some examples, receiving the second indication information sent by the network device in the step 601 may include one of:
receiving a first message sent by the network device, wherein the first message carries the early measurement configuration and the second indication information; or
receiving a second message sent by the network device, wherein the second message carries the second indication information, and is different from a first message carrying the early measurement configuration sent by the network device to the UE.

In some examples, the first message includes an RRC release message and/or a system message. The system message is for example an SIB 4 in an NR system and/or an SIB5 in an LTE/E-UTRAN system.

In some examples, the second message includes a paging message. The UE in the unconnected state in the resident cell may monitor a paging channel of that cell. The paging message is sent by the network device and may carry the second indication information.

In some examples, the first indication information and the second indication information are carried in the RRC release message or system message.

In some other examples, the first indication information is carried in the RRC release message and the second indication information is carried in the system message; alternatively, the second indication information is carried in the RRC release message and the first indication information is carried in the system message.

In yet other examples, the first indication information is carried in the RRC release message or system message and the second indication information is carried in the paging message; alternatively, the second indication information is carried in the RRC release message or system message and the first indication information is carried in the paging message.

The enhanced measurement delay requirement to be satisfied when the UE performs the first early measurement indicated by the second indication information is higher than the measurement delay requirement to be satisfied when the UE performs the first early measurement.

For example, the measurement delay requirement to be satisfied when the UE performs the second early measurement is 1000 ms, and the enhanced measurement delay requirement to be satisfied when the UE performs the first early measurement is 300 ms.

In an embodiment, the second indication information is configured to indicate at least one of:
an enhanced L1 measurement delay requirement; or
an enhanced L3 measurement delay requirement.

In some examples, the enhanced L1 measurement delay requirement is not less than the enhanced L3 measurement delay requirement.

In an embodiment, the to-be-measured carrier includes at least one of:
a NR carrier; or
an E-UTRAN carrier.

In the embodiment, the UE may perform the first early measurement for the E-UTRAN carrier and/or the frequency point supported by the E-UTRAN carrier to obtain the measurement result of the first early measurement.

In some examples, the UE may perform the first early measurement for the NR carrier when residing in the NR cell, and the measurement result of the first early measurement may be used for the configuration of the NR secondary cell group or the NR secondary cell in the NR-DC, NE-DC, or NR CA.

In some other examples, the UE may perform the first early measurement for the E-UTRAN carrier when residing in the NR cell, and the measurement result of the first early measurement may be used for the configuration of the E-UTRAN secondary cell group in the NE-DC.

In some further examples, the UE may perform the first early measurement for the NR carrier when residing in the LTE cell, and the measurement result of the first early measurement may be used for the configuration of the NR secondary cell group in the EN-DC.

In yet further examples, the UE may perform the first early measurement for the E-UTRAN carrier when residing in the LTE cell, and the measurement result of the first early measurement may be used for the configuration of the E-UTRAN secondary cell group in the EN-DC.

In an embodiment, the method may further include:
sending the measurement result of the first early measurement to the network device after the UE enters the connected state from the non-connected state.

In some examples, the non-connected state includes the idle state and/or inactive state.

In an embodiment, the method may further include:
deleting the measurement result of the first early measurement after the UE has successfully sent the measurement result of the first early measurement to the network device.

In the embodiment, the UE obtains the measurement result by performing the first early measurement in the unconnected state, and after entering the connected state from the unconnected state, the UE may immediately report the measurement result of the first early measurement to the network device, so that the network device quickly configures the CA carrier or dual connectivity for the UE based on the measurement result of the unconnected state reported by the UE.

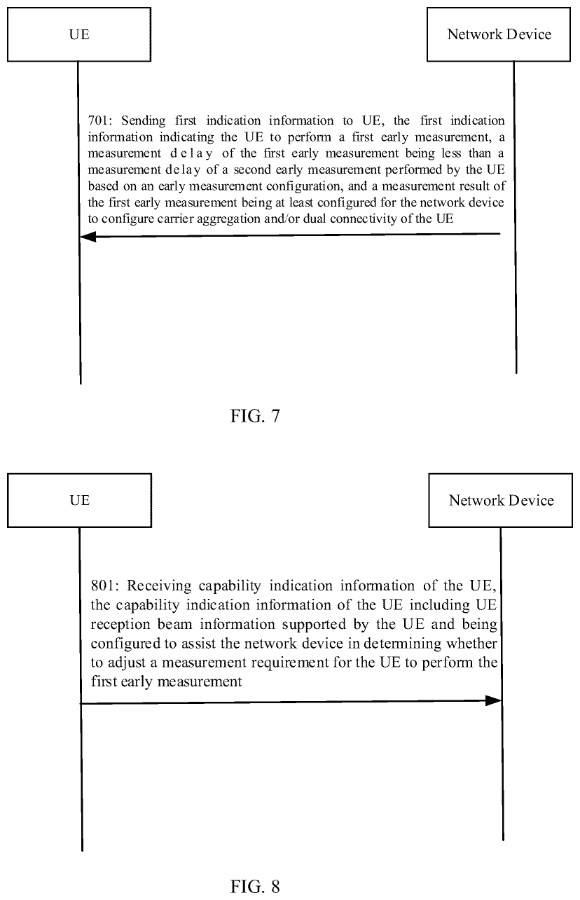

FIG. 7 is a flow diagram of an information processing method illustrated according to an embodiment. The information processing method is performed by a network device, and as shown in FIG. 7, the method may include:
step 701, sending first indication information to a UE, wherein the first indication information is configured to indicate the UE to perform a first early measurement, a measurement delay of the first early measurement is less than a measurement delay of a second early measurement performed by the UE based on an early measurement configuration, and a measurement result of the first early measurement is at least configured for the network device to configure carrier aggregation and/or dual connectivity of the UE.

Herein, the UE may be a mobile phone, a tablet computer, a laptop computer, a personal digital assistant, a wearable device, an Internet of Things device, a narrow-band IoT device or the like.

The UE has a non-connected state and a connected state. For example, the wireless communication system of the UE is an LTE system, and the non-connected state refers to an idle state. The wireless communication system of the UE is a 5G NR system, and the non-connected state includes an idle state and an inactive state.

The UE may communicate with more than one network device and more than one type of network device simultaneously and/or be configured to communicate with them respectively. For example, the UE may have a dual connectivity with a network device supporting LTE and a network device supporting NR. As an example, the UE may communicate with an eNB for LTE/E-UTRAN and a gNB for NR/NG-RAN.

The network device may be a base station, such as a gNB or an eNB or a base station in a subsequent evolved communication system.

In some examples, the first indication information may be configured to indicate a carrier to be measured when the UE performs the first early measurement.

The carrier to be measured by the first early measurement may be a potential carrier aggregation and/or a secondary carrier of a dual connectivity.

For example, the first indication information may include measurement carrier information, and the measurement carrier information indicates the carrier to be measured by the first early measurement.

In some examples, the number of carriers to be measured by the first early measurement is less than the number of carriers to be measured by the second early measurement.

In some examples, sending the first indication information to the UE in step 701 may include one of:
sending a first message to the UE, wherein the first message carries the early measurement configuration and the first indication information; or
sending a second message to the UE, wherein the second message carries the first indication information and is different from a first message carrying the early measurement configuration and sent to the UE by the network device.

In some examples, the first message includes an RRC release message and/or a system message. The system message is for example an SIB 4 in an NR system and/or an SIB5 in an LTE/E-UTRAN system.

In some examples, the second message includes a paging message. The UE in the unconnected state in a resident cell may monitor a paging channel of that cell. The paging message is sent by the network device and may carry the first indication information.

In some examples, the early measurement configuration may include a list of to-be-measured carriers, configuration information of each to-be-measured carrier in the list of to-be-measured carriers, and a measurement reporting configuration. In addition, the early measurement configuration may include whether to configure a DRX timer for the UE, a cycle length of a specific configured DRX, or the like.

The configuration information of the to-be-measured carrier is configured to indicate a specific configuration of the UE to perform the early measurement for that to-be-measured carrier.

In some examples, the configuration information of the to-be-measured carrier includes, but is not limited to, measurement frequency point information, a list of measurement cells, and/or measurement frequency band information (e.g., frequency band indicator), etc.

The measurement frequency point information may include an absolute frequency point number for the NR carrier (e.g., ARFCN-ValueNR) and/or an absolute frequency point number for the E-UTRAN carrier (e.g., ARFCN-ValueEUTRA).

The measurement frequency band information is used for a frequency range of the to-be-measured carrier. The frequency band information includes an FR1 and/or an FR2. The FR1 is the 5G Sub-6 GHZ (below 6 GHz) band and the FR2 is the 5G millimeter wave band.

In some examples, when the to-be-measured carrier is an NR carrier, the configuration information of the to-be-measured carrier may include a measurement configuration of an SSB at a frequency point of the to-be-measured carrier, for example, an SMTC, SSB index information to be measured (e.g., an indication as to which SSB is to be measured), a number of SSBs to be averaged and/or a number of threshold SSBs to be merged, etc.

In some examples, the measurement reporting configuration may be used to indicate a reporting type, a quality threshold, and a number of beam-based measurements.

In some examples, the reporting type includes at least one of RSRP, RSRQ, or SINR.

The measurement result of the first early measurement may be used for the configuration of carrier aggregation and/or dual connectivity of the UE by the network device.

Specifically, the measurement result of the first early measurement may be used for the configuration of a secondary cell group or a secondary cell in carrier aggregation and/or dual connectivity of the UE by the network device.

The dual connectivity may be a dual connectivity of LTE and NR, specifically, a dual connectivity between E-UTRAN and NR, such as EN-DC or NE-DC, or a dual connectivity between two NR nodes, i.e., NR-DC.

In the information processing method provided by the embodiment of the present disclosure, the network device sends the first indication information to the UE, the first indication information is configured to indicate the UE to perform the first early measurement, and the measurement delay of the first early measurement is less than the measurement delay of the second early measurement performed by the UE based on the early measurement configuration, so the UE performs the first early measurement based on the first indication information, which may reduce the delay caused by the early measurement execution, and thus enables fast configuration of carrier aggregation and/or dual connectivity of the UE.

In an embodiment, the first indication information includes:
measurement carrier information, configured to indicate a to-be-measured carrier.

In some examples, the to-be-measured carrier may be a downlink carrier or a carrier for downlink.

In some examples, the to-be-measured carrier indicated by the measurement carrier information may be included in the to-be-measured carrier indicated by the early measurement configuration, and the number of to-be-measured carriers indicated by the measurement carrier information is less than the number of to-be-measured carriers indicated by the early measurement configuration.

In the embodiment, the network device sends the first indication information to the UE, so the UE may perform the first early measurement based on the measurement carrier information included in the first indication information, such that the delay caused by performing the early measurement is reduced by performing the first early measurement with a smaller number of measurement carriers, and a fast configuration of carrier aggregation and/or dual connectivity of the UE is possible.

In an embodiment, the measurement result is obtained by the UE performing, at a first time, the first early measurement based on the first indication information.

In some examples, the first time may be a protocol-agreed time, a time indicated by the network device, or a time autonomously determined by the UE.

In an embodiment, the first indication information may include the first time or information related to the first time, so the UE may determine the first time based on the first indication information.

In an embodiment, the first time includes at least one of the following 1) to 4).

1) A Time at which the UE Receives a Paging Message from a Service Cell

The UE in the unconnected state in a resident cell monitors the paging channel of that cell. The paging message is sent by the network device and the UE in the unconnected state only monitors one paging time in a DRX cycle.

In some examples, the first time is a paging time at which the UE receives the paging message. In this case, regardless of whether the UE is paged or not, as long as the paging message is received by the UE at the paging time, the paging time may be used as the first time.

In some other examples, the first time is a paging time at which the UE receives a paging message for paging the UE. The paging message for paging the UE carries identification information of the UE. In this case, if the UE receives the paging message for paging the UE at the paging time, the paging time may be used as the first time.

In some examples, the paging message is higher-layer RRC signaling, which may be MAC layer signaling. For example, the paging message may be carried in a MAC CE.

2) a Time at which the UE Sends a Random Access Preamble to the Network Device

When the UE in the unconnected state access to the network and obtains an RRC connection, it first performs a random access procedure. During the random access procedure, the UE sends to the network device an MSG1 (message 1): a random access preamble.

The random access preamble may be used to inform the access network device about the random access request of the UE.

3) A Time at which the UE Sends an RRC Connection Setup Request to the Network Device

When the UE is in the idle state, the RRC connection setup process may be triggered when the UE is paged or wishes to initiate a paging. During the RRC connection setup process, the UE sends an RRC setup request to a network device (e.g., a base station). The time at which the UE sends the RRC connection setup request to the network device may be used as the first time.

4) a Time at which the UE Sends an RRC Connection Resume Request to the Network Device

When the UE is in the inactive state, the RRC connection resume process may be triggered when the UE is paged or has uplink data arrived. Unlike the UE in the idle state, the core network maintains the connection to the UE in the inactive state and the source network device keeps the context of that UE. The UE in the inactive state resumes the connection to the access network through the RRC resume process and resumes the connection to the core network. During the RRC connection resume process, the UE may send an RRC resume request to the network device. The time at which the UE sends the RRC connection resume request to the network device may be used as the first time.

In an embodiment of the present disclosure, the measurement result of the first early measurement is obtained by the UE performing the first early measurement based on the first indication information at any of the above first times, which may further reduce the delay caused by the early measurement, so that the network device may obtain the measurement result as soon as possible, and thus fast configure carrier aggregation and/or dual connectivity of the UE.

In an embodiment, the measurement result is obtained by the UE performing, at the first time, the first early measurement based on the first indication information in a case where the second early measurement performed by the UE based on the early measurement configuration satisfies a first condition.

In an embodiment, the first condition includes at least one of:
a measurement result of the second early measurement performed by the UE based on the early measurement configuration being invalid; or
the UE not obtaining the measurement result of the second early measurement performed based on the early measurement configuration.

If the cell reselected to by the UE in the unconnected state is a first cell, the measurement result of the second early measurement performed by the UE in a second cell before the cell reselection is invalid. Here, the first cell is different from the second cell.

If the UE stops the second early measurement after the UE enters the connected state from the unconnected state or moves out of the effective area or performs an Inter-RAT reselection during the execution of the second early measurement, the UE may not obtain the measurement result of the second early measurement.

In the embodiment, as the measurement result of the first early measurement is obtained by the UE performing, at the first time, the first early measurement based on the first indication information in the case where the second early measurement performed by the UE based on the early measurement configuration satisfies the first condition, the network device may obtain a reliable early measurement result as early as possible, and fast configuration of aggregated carrier and/or dual connectivity of the UE may be realized.

In an embodiment, the first early measurement includes at least one of:
a layer 1 reference signal receiving power (L1-RSRP) measurement; or
a layer 3 reference signal receiving power (L3-RSRP) measurement.

The L1-RSRP measurement is an RSRP measurement based on layer 1 (physical layer), which RSRP measurement is not subject to the filtering process of layer 3 (network layer). In comparison with the L3-RSRP measurement, the L1-RSRP measurement allows for faster beam information measurement and reporting.

In some examples, both L1-RSRP and L3-RSRP measurements may be RSRP measurements performed based on SSB. In the downlink direction, a plurality of SSBs may be transmitted in a carrier band, and the SSB is transmitted to the UE with a fixed cycle, which may be 5 ms, 10 ms, 20 ms, 40 ms, 80 ms, or 160 ms. The UE may measure the RSRP for the received SSB.

In an embodiment, as shown in FIG. 8, the method may further include:
step 801, receiving capability indication information of the UE, wherein the capability indication information of the UE includes UE reception beam information supported by the UE and is configured to assist the network device in determining whether to adjust a measurement requirement for the UE to perform the first early measurement.

In some examples, the UE reception beam information may include a number of UE reception beams.

The network device may receive the capability information regarding the number of reception beams of the UE reported by the UE to the network device via IE MeasAndMobParameters or IE MeasAndMobParametersMRDC of MR-DC capability.

For example, if the number of reception beams X reported by the UE is 4, it means that the UE supports the simulation of reception beams in 4 different directions to receive the physical downlink control channel (PDCCH) and/or the physical downlink shared channel (PDSCH).

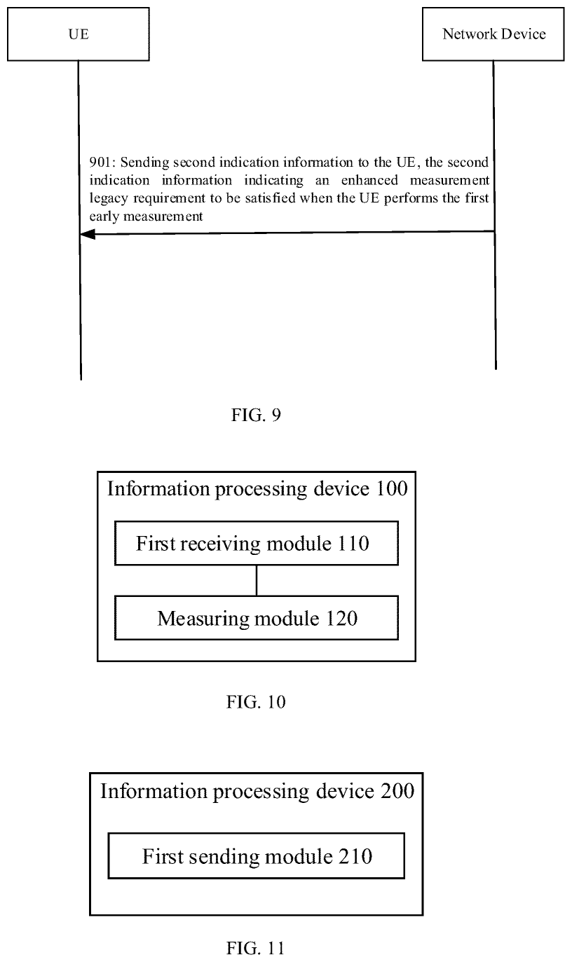

In an embodiment, as shown in FIG. 9, the method further includes:
step 901, sending second indication information to the UE, wherein the second indication information is configured to indicate an enhanced measurement delay requirement to be satisfied when the UE performs the first early measurement.

In some examples, sending the second indication information to the UE in step 901 may include one of:
sending a first message to the UE, wherein the first message carries the early measurement configuration and the second indication information; or
sending a second message to the UE, wherein the second message carries the second indication information, and is different from a first message carrying the early measurement configuration sent by the network device to the UE.

In some examples, the first message includes an RRC release message and/or a system message. The system message is for example an SIB 4 in an NR system and/or an SIB5 in an LTE/E-UTRAN system.

In some examples, the second message includes a paging message. The UE in the unconnected state in the resident cell may monitor a paging channel of that cell. The paging message is sent by the network device and may carry the second indication information.

In some examples, the first indication information and the second indication information are carried in the RRC release message or system message.

In some other examples, the first indication information is carried in the RRC release message and the second indication information is carried in the system message; alternatively, the second indication information is carried in the RRC release message and the first indication information is carried in the system message.

In yet other examples, the first indication information is carried in the RRC release message or system message and the second indication information is carried in the paging message; alternatively, the second indication information is carried in the RRC release message or system message and the first indication information is carried in the paging message.

The enhanced measurement delay requirement to be satisfied when the UE performs the first early measurement indicated by the second indication information is higher than the measurement delay requirement to be satisfied when the UE performs the first early measurement.

For example, the measurement delay requirement to be satisfied when the UE performs the second early measurement is 1000 ms, and the enhanced measurement delay requirement to be satisfied when the UE performs the first early measurement is 300 ms.

In an embodiment, the second indication information is configured to indicate at least one of:
an enhanced L1 measurement delay requirement; or
an enhanced L3 measurement delay requirement.

In some examples, the enhanced L1 measurement delay requirement is not less than the enhanced L3 measurement delay requirement.

In an embodiment, the to-be-measured carrier includes at least one of:
a NR carrier; or
an E-UTRAN carrier.

In the embodiment, the network device may indicate the UE to perform the first early measurement for the E-UTRAN carrier and/or the frequency point supported by the E-UTRAN carrier to obtain the measurement result of the first early measurement.

In some examples, the UE may perform the first early measurement for the NR carrier when residing in the NR cell, and the measurement result of the first early measurement may be used for the configuration of the NR secondary cell group or the NR secondary cell in the NR-DC, NE-DC, or NR CA.

In some other examples, the UE may perform the first early measurement for the E-UTRAN carrier when residing in the NR cell, and the measurement result of the first early measurement may be used for the configuration of the E-UTRAN secondary cell group in the NE-DC.

In some further examples, the UE may perform the first early measurement for the NR carrier when residing in the LTE cell, and the measurement result of the first early measurement may be used for the configuration of the NR secondary cell group in the EN-DC.

In yet further examples, the UE may perform the first early measurement for the E-UTRAN carrier when residing in the LTE cell, and the measurement result of the first early measurement may be used for the configuration of the E-UTRAN secondary cell group in the EN-DC.

In an embodiment, the method may further include:
receiving the measurement result of the first early measurement sent by the UE after entering the connected state from the non-connected state.

In some examples, the non-connected state includes the idle state and/or inactive state.

In the embodiment, the network device receives the measurement result of the first early measurement sent by the UE after entering the connected state from the non-connected state, so that it can quickly configure the CA carrier or dual connectivity for the UE based on the measurement result of the unconnected state reported by the UE.

To further explain any embodiments of the present disclosure, several specific embodiments are provided below.

An embodiment of the present disclosure provides an information processing method, and the method may include the following steps.

In S1, the network device configures carrier indication information (e.g., first indication information in the above embodiment) for enhanced measurement to the UE, so that the UE performs the enhanced measurement on the carrier indicated by the carrier indication information.

The network device configures the carrier indication information for the enhanced measurement via IE MeasIdleConfig (measurement idle configuration), so that when the UE needs to perform the enhanced measurement for the CA and/or DC configurations in the idle state or the inactive state, the UE may perform, at an agreed time point, the enhanced measurement (e.g., the first early measurement in the above embodiment) for the carrier indicated by the carrier indication information.

The IE MeasIdleConfig is used to communicate, to the UE, information indicating the UE to perform an early measurement in the idle state or inactive state. The network device may send an early measurement configuration and the carrier indication information to the UE based on the measurement idle configuration information element (IE) in the RRC connection release message.

The indicated carrier may be an NR carrier or an E-UTRAN carrier and the agreed time point may be one of:
a time point 1 after the UE receives a paging message from a serving cell;
a time point 2 after the UE sends a Msg1 message to the network;
a time point 3 after the UE sends an RRC connection setup request (Msg3) to the network; or
a time point 4 after the UE sends an RRC connection resume request to the network device.

Example 1: the UE in the idle or inactive state completes an EMR measurement (e.g., the second early measurement in the above embodiment) based on the information of the early measurement configuration in the IE MeasIdleConfig, and when the measurement result of the EMR measurement is invalid or inaccessible, the UE performs the enhanced measurement configured for the CA and/or DC, and the UE may perform a corresponding measurement based on the first indication information of the enhanced measurement configured by the network, and the measurement may be performed in at least one of the following manners:
a manner 1: the L1-RSRP measurement is performed for the to-be-measured carrier as described above, and the corresponding measurement requirement may satisfy either the existing delay requirement or the enhanced requirement, depending on the capability of the UE; or
a manner 2: the L3 RSRP measurement is performed for the to-be-measured carrier as described above, and the corresponding measurement requirement may satisfy the existing delay requirement or the enhanced requirement, depending on the capability of the UE.

In S2, the UE reports UE reception (Rx) beam capability indication information supported by the UE to the network device, and based on the capability indication information, the network device configures for the UE whether or not to apply enhanced measurement requirement indication information (e.g., the second indication information in the above embodiment).

The UE may report, to the network device, the capability indication information regarding the number of Rx beams (X) supported by the UE itself, where X denotes the number of Rx beams simulated by the UE, and X is an integer greater than 1. Based on the received capability indication information regarding X, the network device configures the indication information for applying the enhanced measurement requirement via the IE MeasIdleConfig. The enhanced measurement requirement may include at least one of:
an enhanced L1 measurement delay requirement; or
an enhanced L3 measurement delay requirement.

Example 1: the UE reports the capability information regarding the number of reception beams of the UE itself to the network device via IE MeasAndMobParameters or IE MeasAndMobParametersMRDC, e.g., if X=4, the UE supports the simulation of reception beams in 4 different directions to receive PDCCH and/or PDSCH. When the UE enters the idle state or the inactive state from the connected state, the network device configures CA and/or DC related measurement information to the UE via IE MeasIdleConfig configuration, the measurement information may include indication information regarding whether or not an enhanced measurement requirement is applied when the UE performs an enhanced measurement for the carrier indicated by the carrier indication information, and if yes, the UE performs a corresponding measurement based on the agreed enhanced measurement requirement.

In the technical solution provided by the embodiment of the present disclosure, when the UE needs to perform the enhanced measurement configured for CA and/or DC in the idle state or the inactive state, the UE may perform the enhanced measurement on the indicated carrier at an agreed time and configure whether to apply the indication information of the enhanced measurement requirement based on the UE capability, which achieves the effect of quickly and efficiently establishing the SCG or SCell.

FIG. 10 is a structure diagram of an information processing device according to an embodiment. The information processing device is applied to a UE, and as shown in FIG. 10, and the information processing device 100 may include:
a first receiving module 110, configured to receive first indication information sent by a network device, wherein the first indication information is configured to indicate the UE to perform a first early measurement, and a measurement delay of the first early measurement is less than a measurement delay of a second early measurement performed by the UE based on an early measurement configuration; and
a measuring module 120, configured to perform the first early measurement based on the first indication information, wherein a measurement result of the first early measurement is at least configured for the network device to configure carrier aggregation and/or dual connectivity of the UE.

In an embodiment, the first indication information includes:
measurement carrier information, configured to indicate a to-be-measured carrier.

In an embodiment, the measuring module 120 is configured to:
perform, at a first time, the first early measurement based on the first indication information.

In an embodiment, the first time includes at least one of:
a time at which the UE receives a paging message from a service cell;
a time at which the UE sends a random access preamble to the network device;
a time at which the UE sends an RRC connection setup request to the network device; or
a time at which the UE sends an RRC connection resume request to the network device.

In an embodiment, the measuring module 120 is configured to:
perform, at the first time, the first early measurement based on the first indication information in a case where the second early measurement performed by the UE based on the early measurement configuration satisfies a first condition.

In an embodiment, the first condition includes at least one of:
a measurement result of the second early measurement performed by the UE based on the early measurement configuration being invalid; or
the UE not obtaining the measurement result of the second early measurement performed based on the early measurement configuration.

In an embodiment, the first early measurement includes at least one of:
an L1-RSRP measurement; or
an L3-RSRP measurement.

In an embodiment, the device further includes:
a first sending module, configured to send capability indication information of the UE to the network device, wherein the capability indication information of the UE includes UE reception beam information supported by the UE and is configured to assist the network device in determining whether to adjust a measurement requirement for the UE to perform the first early measurement.

In an embodiment, the device further includes:
a receiving module, configured to receive second indication information sent by the network device, wherein the second indication information is configured to indicate an enhanced measurement delay requirement to be satisfied when the UE performs the first early measurement, and
the measuring module is configured to:
perform the first early measurement based on the first indication information and the second indication information.

In an embodiment, the second indication information is configured to indicate at least one of:
an enhanced L1 measurement delay requirement; or
an enhanced L3 measurement delay requirement.

In an embodiment, the to-be-measured carrier includes at least one of:
a new radio (NR) carrier; or
an evolved universal terrestrial radio access network (E-UTRAN) carrier.

In an embodiment, the device further includes:
a second sending module, configured to send the measurement result of the first early measurement to the network device after the UE enters a connected state from an unconnected state.

FIG. 11 is a structure diagram of an information processing device according to an embodiment. The information processing device is applied to a network device, and as shown in FIG. 11, the information processing device 200 may include:
a first sending module 210, configured to send first indication information to a user equipment (UE), wherein the first indication information is configured to indicate the UE to perform a first early measurement, a measurement delay of the first early measurement is less than a measurement delay of a second early measurement performed by the UE based on an early measurement configuration, and a measurement result of the first early measurement is at least configured for the network device to configure carrier aggregation and/or dual connectivity of the UE.

In an embodiment, the first indication information includes:
measurement carrier information, configured to indicate a to-be-measured carrier.

In an embodiment, the measurement result is obtained by the UE performing, at a first time, the first early measurement based on the first indication information.

In an embodiment, the first time includes at least one of:
a time at which the UE receives a paging message from a service cell;
a time at which the UE sends a random access preamble to the network device;
a time at which the UE sends an RRC connection setup request to the network device; or
a time at which the UE sends an RRC connection resume request to the network device.

In an embodiment, the measurement result is obtained by the UE performing, at the first time, the first early measurement based on the first indication information in a case where the second early measurement performed by the UE based on the early measurement configuration satisfies a first condition.

In an embodiment, the first condition includes at least one of:
a measurement result of the second early measurement performed by the UE based on the early measurement configuration being invalid; or
the UE not obtaining the measurement result of the second early measurement performed based on the early measurement configuration.

In an embodiment, the first early measurement includes at least one of:
an L1-RSRP measurement; or
an L3-RSRP measurement.

In an embodiment, the device further includes:
a first receiving module, configured to receive capability indication information of the UE, wherein the capability indication information of the UE includes UE reception beam information supported by the UE and is configured to assist the network device in determining whether to adjust a measurement requirement for the UE to perform the first early measurement.

In an embodiment, the device further includes:
a second sending module, configured to send second indication information to the UE, wherein the second indication information is configured to indicate an enhanced measurement delay requirement to be satisfied when the UE performs the first early measurement.

In an embodiment, the second indication information is configured to indicate at least one of:
an enhanced L1 measurement delay requirement; or
an enhanced L3 measurement delay requirement.

In an embodiment, the to-be-measured carrier includes at least one of:
a new radio (NR) carrier; or
an evolved universal terrestrial radio access network (E-UTRAN) carrier.

In an embodiment, the device further includes:
a second receiving module, configured to receive the measurement result of the first early measurement sent by the UE after the UE enters a connected state from an unconnected state.

An embodiment of the present disclosure provides a communication system including a user equipment (UE) and a network device:

The network device is configured to send first indication information to the UE, wherein the first indication information is configured to indicate the UE to perform a first early measurement, and a measurement delay of the first early measurement is less than a measurement delay of a second early measurement performed by the UE based on an early measurement configuration.

The UE is configured to receive the first indication information sent by the network device, and to perform the first early measurement based on the first indication information, wherein a measurement result of the first early measurement is at least configured for the network device to configure carrier aggregation and/or dual connectivity of the UE.

In an embodiment, the first indication information includes:
measurement carrier information, configured to indicate a to-be-measured carrier.

In an embodiment, the UE is configured to:
perform, at a first time, the first early measurement based on the first indication information.

In an embodiment, the first time includes at least one of:
a time at which the UE receives a paging message from a service cell;
a time at which the UE sends a random access preamble to the network device;
a time at which the UE sends an RRC connection setup request to the network device; or
a time at which the UE sends an RRC connection resume request to the network device.

In an embodiment, the UE is configured to:
perform, at the first time, the first early measurement based on the first indication information in a case where the second early measurement performed by the UE based on the early measurement configuration satisfies a first condition.

In an embodiment, the first condition includes at least one of:
a measurement result of the second early measurement performed by the UE based on the early measurement configuration being invalid; or
the UE not obtaining the measurement result of the second early measurement performed based on the early measurement configuration.

In an embodiment, the first early measurement includes at least one of:
an L1-RSRP measurement; or
an L3-RSRP measurement.

In an embodiment, the UE is configured to:
send capability indication information of the UE to the network device, wherein the capability indication information of the UE includes UE reception beam information supported by the UE and is configured to assist the network device in determining whether to adjust a measurement requirement for the UE to perform the first early measurement.

In an embodiment, the network device is configured to:
receive capability indication information of the UE.

In an embodiment, the network device is configured to:
send second indication information to the UE, wherein the second indication information is configured to indicate an enhanced measurement delay requirement to be satisfied when the UE performs the first early measurement.

In an embodiment, the UE is configured to:
receive the second indication information sent by the network device; and
perform the first early measurement based on the first indication information and the second indication information.

In an embodiment, the second indication information is configured to indicate at least one of:
an enhanced L1 measurement delay requirement; or
an enhanced L3 measurement delay requirement.

In an embodiment, the to-be-measured carrier includes at least one of:
a new radio (NR) carrier; or
an evolved universal terrestrial radio access network (E-UTRAN) carrier.

In an embodiment, the UE is configured to:
send the measurement result of the first early measurement to the network device after the UE enters a connected state from an unconnected state.

An embodiment of the present disclosure provides a communication device, including:
a processor; and
a memory for storing executable instructions of the processor;
wherein the processor is configured to implement the information processing method provided by any of the foregoing technical solutions when running the executable instructions.

The processor may include various types of storage media that are non-transitory computer storage media and can keep information stored thereon after the communication device is powered down.

Here, the communication device may include, but is not limited to, at least one of a UE and a network device.

The processor may be connected to the memory via a bus or the like to read an executable program stored on the memory, e.g., at least one of the information processing methods as shown in FIGS. 2 to 9.

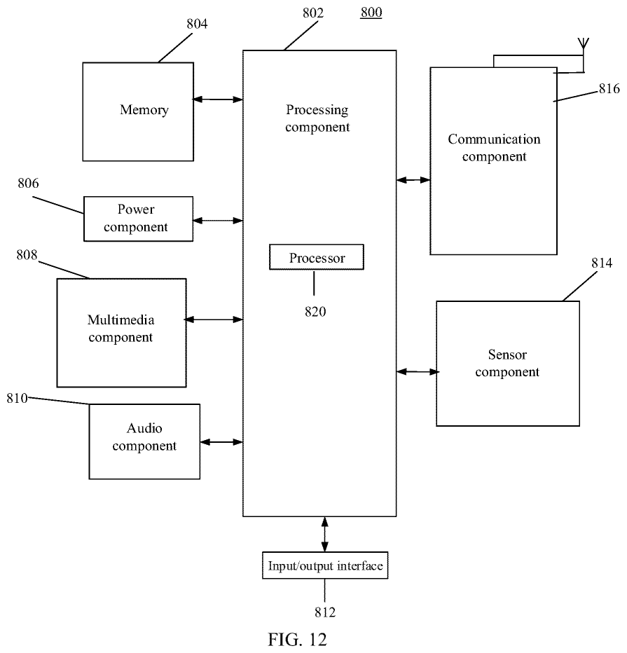

FIG. 12 is a block diagram of a UE 800 according to an embodiment. For example, the UE 800 may be a mobile phone, a computer, a digital broadcasting device, a messaging device, a game console, a tablet device, a medical device, a fitness device, a personal digital assistant, or the like.

Referring to FIG. 12, the UE 800 may include one or more of a processing component 802, a memory 804, a power component 806, a multimedia component 808, an audio component 810, an input/output (I/O) interface 812, a sensor component 814, and a communication component 816.

The processing component 802 generally controls the overall operations of the UE 800, such as operations associated with display, telephone calls, data communications, camera operations, and recording operations. The processing component 802 may include one or more processors 820 to execute instructions to generate all or part of the steps of the foregoing method. In addition, the processing component 802 may include one or more modules to facilitate interaction between the processing component 802 and other components. For example, the processing component 802 may include a multimedia module to facilitate the interaction between the multimedia component 808 and the processing component 802.

The memory 804 is configured to store various types of data to support the operation at the UE 800. Examples of these data include instructions for any application or method operating on the UE 800, contact data, phone book data, messages, pictures, videos and the like. The memory 804 may be implemented by any type of volatile or non-volatile storage device or a combination thereof, such as static random access memory (SRAM), electrically erasable programmable read-only memory (EEPROM), erasable and programmable read-only memory (EPROM), programmable read-only memory (PROM), read-only memory (ROM), magnetic memory, flash memory, magnetic disk or optical disk.

The power component 806 provides power to various components of the UE 800. The power component 806 may include a power management system, one or more power supplies, and other components associated with generating, managing, and distributing power for the UE 800.

The multimedia component 808 includes a screen that provides an output interface between the UE 800 and the user. In some embodiments, the screen may include a liquid crystal display (LCD) and a touch panel (TP). If the screen includes a touch panel, the screen may be implemented as a touch screen to receive input signals from the user. The touch panel includes one or more touch sensors to sense touch, sliding, and gestures on the touch panel. The touch sensor may not only sense the boundary of the touch or slide action, but also detect the duration and pressure related to the touch or slide operation. In some embodiments, the multimedia component 808 includes a front camera and/or a rear camera. When the UE 800 is in an operation mode, such as a shooting mode or a video mode, the front camera and/or the rear camera can receive external multimedia data. Each of the front camera and rear camera may be a fixed optical lens system or have focal length and optical zoom capabilities.

The audio component 810 is configured to output and/or input audio signals. For example, the audio component 810 includes a microphone (MIC), and when the UE 800 is in an operation mode, such as a call mode, a recording mode, and a voice recognition mode, the microphone is configured to receive an external audio signal. The received audio signal can be further stored in the memory 804 or sent via the communication component 816. In some embodiments, the audio component 810 further includes a speaker for outputting audio signals.

The I/O interface 812 provides an interface between the processing component 802 and a peripheral interface module. The above-mentioned peripheral interface module may be a keyboard, a click wheel, a button, and the like. These buttons may include but are not limited to home button, volume button, start button, and lock button.

The sensor component 814 includes one or more sensors for providing the UE 800 with various aspects of state evaluation. For example, the sensor component 814 can detect the on/off status of the UE 800 and the relative positioning of components. For example, the component is a display and keypad of the UE 800. The sensor component 814 can also detect the position change of the UE 800 or a component of the UE 800, the presence or absence of contact between the user and the UE 800, the orientation or acceleration/deceleration of the UE 800, and the temperature change of the UE 800. The sensor component 814 may include a proximity sensor configured to detect the presence of nearby objects when there is no physical contact. The sensor component 814 may also include a light sensor, such as a CMOS or CCD image sensor, for use in imaging applications. In some embodiments, the sensor component 814 may also include an acceleration sensor, a gyroscope sensor, a magnetic sensor, a pressure sensor, or a temperature sensor.

The communication component 816 is configured to facilitate wired or wireless communication between the UE 800 and other devices. The UE 800 can access a wireless network based on a communication standard, such as WiFi, 2G, 3G, 4G or 5G, or a combination thereof. In an embodiment, the communication component 816 receives a broadcast signal or broadcast related information from an external broadcast management system via a broadcast channel. In an embodiment, the communication component 816 further includes a near field communication (NFC) module to facilitate short-range communication. For example, the NFC module can be implemented based on radio frequency identification (RFID) technology, infrared data association (IrDA) technology, ultra-wideband (UWB) technology, Bluetooth (BT) technology and other technologies.

In an embodiment, the UE 800 may be implemented by one or more of application specific integrated circuit (ASIC), digital signal processor (DSP), digital signal processing device (DSPD), programmable logic devices (PLD), field programmable gate array (FPGA), controller, microcontroller, microprocessor, or other electronic components, to perform the above-mentioned methods.

An embodiment also provides a non-transitory computer-readable storage medium including instructions, such as the memory 804 including instructions, and the instructions may be executed by the processor 820 of the UE 800 to generate the foregoing method. For example, the non-transitory computer-readable storage medium may be ROM, random access memory (RAM), CD-ROM, magnetic tape, floppy disk, optical data storage device and the like.

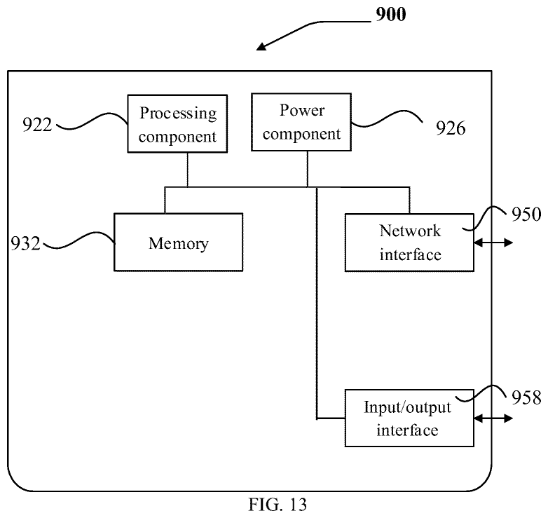

As shown in FIG. 13, an embodiment of the present disclosure provides a structure of a network device. For example, the network device 900 may be provided as a server.

Referring to FIG. 13, the network device 900 includes a processing component 922 which further includes one or more processors, and a memory resource which is represented by a memory 932 and is configured for storing instructions such as application programs executable by the processing component 922. The application program stored in the memory 932 may include one or more modules each corresponding to a set of instructions. Furthermore, the processing component 922 is configured to execute instructions to perform any of the above methods applied to the network device.

The network device 900 may also include a power component 926 configured to perform power management of the network device 900, a wired or wireless network interface 950 configured to connect the network device 900 to a network, and an input/output (I/O) interface 958. The network device 900 may operate based on an operating system stored in memory 932, such as Windows Server™, Mac OS X™, Unix™, Linux™, Free BSD™ or the like.

A person skilled in the art may easily conceive of other embodiments of the present disclosure upon consideration of the specification and practice of the invention disclosed herein. The present disclosure is intended to cover any variations, uses, or adaptations of the present disclosure that follow the general principles of the present disclosure and include the common knowledge or conventional technical means in the technical field not disclosed by the present disclosure. The specification and embodiments are to be regarded as exemplary only, with the true scope and spirit of the present disclosure being indicated by the following claims.

It is to be understood that the present disclosure is not limited to the precise structures described above and illustrated in the accompanying drawings, and that various modifications and changes may be made without departing from the scope thereof. The scope of the present disclosure is limited only by the appended claims.

1. An information processing method, performed by a user equipment (UE), comprising:
receiving first indication information sent by a network device, wherein the first indication information is configured to indicate the UE to perform a first early measurement, and a measurement delay of the first early measurement is less than a measurement delay of a second early measurement performed by the UE based on an early measurement configuration; and
performing the first early measurement based on the first indication information, wherein a measurement result of the first early measurement is at least configured for the network device to configure at least one of carrier aggregation or dual connectivity of the UE.

2. The method according to claim 1, wherein the first indication information comprises:
measurement carrier information, configured to indicate a to-be-measured carrier.

3. The method according to claim 1, wherein performing the first early measurement based on the first indication information comprises:
performing, at a first time, the first early measurement based on the first indication information.

4. The method according to claim 3, wherein the first time comprises at least one of:
a time at which the UE receives a paging message from a service cell;
a time at which the UE sends a random access preamble to the network device;
a time at which the UE sends a radio resource control (RRC) connection setup request to the network device; or
a time at which the UE sends an RRC connection resume request to the network device.

5. The method according to claim 3, wherein performing, at the first time, the first early measurement based on the first indication information comprises:
performing, at the first time, the first early measurement based on the first indication information in response to that the second early measurement performed by the UE based on the early measurement configuration satisfies a first condition.

6. The method according to claim 5, wherein the first condition comprises at least one of:
a measurement result of the second early measurement performed by the UE based on the early measurement configuration being invalid; or
the UE not obtaining the measurement result of the second early measurement performed based on the early measurement configuration.

7. The method according to claim 1, wherein the first early measurement comprises at least one of:
a layer 1 reference signal receiving power (L1-RSRP) measurement; or
a layer 3 reference signal receiving power (L3-RSRP) measurement.

8. The method according to claim 1, further comprising:
sending capability indication information of the UE to the network device, wherein the capability indication information of the UE comprises UE reception beam information supported by the UE and is configured to assist the network device in determining whether to adjust a measurement requirement for the UE to perform the first early measurement.

9. The method according to claim 8, further comprising:
receiving second indication information sent by the network device, wherein the second indication information is configured to indicate an enhanced measurement delay requirement to be satisfied when the UE performs the first early measurement, and
performing the first early measurement based on the first indication information comprises:
performing the first early measurement based on the first indication information and the second indication information,
wherein the second indication information is configured to indicate at least one of:
an enhanced L1 measurement delay requirement; or
an enhanced L3 measurement delay requirement.

10-12. (canceled)

13. An information processing method, performed by a network device, comprising:
sending first indication information to a user equipment (UE), wherein the first indication information is configured to indicate the UE to perform a first early measurement, a measurement delay of the first early measurement is less than a measurement delay of a second early measurement performed by the UE based on an early measurement configuration, and a measurement result of the first early measurement is at least configured for the network device to configure at least one of carrier aggregation or dual connectivity of the UE.

14. The method according to claim 13, wherein the first indication information comprises:
measurement carrier information, configured to indicate a to-be-measured carrier.

15. The method according to claim 13, wherein the measurement result is obtained by the UE performing, at a first time, the first early measurement based on the first indication information.

16. The method according to claim 15, wherein the first time comprises at least one of:
a time at which the UE receives a paging message from a service cell;
a time at which the UE sends a random access preamble to the network device;
a time at which the UE sends a radio resource control (RRC) connection setup request to the network device; or
a time at which the UE sends an RRC connection resume request to the network device.

17. The method according to claim 15, wherein the measurement result is obtained by the UE performing, at the first time, the first early measurement based on the first indication information in response to that the second early measurement performed by the UE based on the early measurement configuration satisfies a first condition.

18. The method according to claim 17, wherein the first condition comprises at least one of:
a measurement result of the second early measurement performed by the UE based on the early measurement configuration being invalid; or
the UE not obtaining the measurement result of the second early measurement performed based on the early measurement configuration.

19. The method according to claim 13, wherein the first early measurement comprises at least one of:
a layer 1 reference signal receiving power (L1-RSRP) measurement; or
a layer 3 reference signal receiving power (L3-RSRP) measurement.

20. The method according to claim 13, further comprising:
receiving capability indication information of the UE, wherein the capability indication information of the UE comprises UE reception beam information supported by the UE and is configured to assist the network device in determining whether to adjust a measurement requirement for the UE to perform the first early measurement.

21. The method according to claim 20, further comprising:
sending second indication information to the UE, wherein the second indication information is configured to indicate an enhanced measurement delay requirement to be satisfied when the UE performs the first early measurement,
wherein the second indication information is configured to indicate at least one of:
an enhanced L1 measurement delay requirement; or
an enhanced L3 measurement delay requirement.

22-29. (canceled)

30. A user equipment (UE), comprising:
a processor; and
a memory storing executable instructions for the processor,
wherein the executable instructions, when being executed by the processor, cause the UE to implement actions comprising:
receiving first indication information sent by a network device, wherein the first indication information is configured to indicate the UE to perform a first early measurement, and a measurement delay of the first early measurement is less than a measurement delay of a second early measurement performed by the UE based on an early measurement configuration; and
performing the first early measurement based on the first indication information, wherein a measurement result of the first early measurement is at least configured for the network device to configure at least one of carrier aggregation or dual connectivity of the UE.

31. A network device, comprising:
a processor; and
a memory storing executable instructions for the processor,
wherein the executable instructions, when being executed by the processor, cause the network device to implement the method according to claim 13.
